(19) United States
(12) Patent Application Publication
(10) Pub. No.: US 2025/0068048 A1
(43) Pub. Date: Feb. 27, 2025

(54) PROJECTION DEVICE AND AUTO-FOCUS METHOD THEREOF

(71) Applicant: Coretronic Corporation, Hsin-Chu (TW)

(72) Inventor: Chih-Chen Chen, Hsin-Chu (TW)

(73) Assignee: Coretronic Corporation, Hsin-Chu (TW)

(21) Appl. No.: 18/795,116

(22) Filed: Aug. 5, 2024

(30) Foreign Application Priority Data
Aug. 25, 2023 (CN) 202311076910.3

(51) Int. Cl. G03B 21/53; G02B 7/28

(52) U.S. Cl. CPC G03B 21/53; G02B 7/28

(57) ABSTRACT

A projection device and an auto-focus method of the projection device are provided. A projection distance between a projection lens of the projection device and a projection surface is detected to generate a distance detection signal. A control unit updates an expanded look-up table based on the original look-up table, the distance detection signal, an optimal motor step, and an adjustment completion time, where the optimal motor step and the adjustment completion time are obtained through a manual focus operation. An auto-focus operation is performed based on the distance detection signal and the updated expanded look-up table.

### CROSS-REFERENCE TO RELATED APPLICATION

This application claims the priority benefit of China application serial no. 202311076910.3, filed on Aug. 25, 2023. The entirety of the above-mentioned patent application is hereby incorporated by reference herein and made a part of this specification.

### BACKGROUND OF THE INVENTION

### 1. Field of the Invention

The invention relates to a display device and particularly relates to a projection device and an auto-focus method thereof.

### 2. Description of Related Art

Recently, there is a growing prominence of a distance-measuring auto-focus technology employed in projectors. This technology involves the utilization of distance-measuring elements, including but not limited to laser distance sensors, infrared (IR) distance sensors, or ultrasonic distance sensors. These elements are applicable to measure a projection distance between a lens of the projector and a projection screen. The projector, in response to the measured projection distance, autonomously engages a motor connected to the lens. The motor facilitates stepwise movements of the lens to a corresponding position, leading to the extension or retraction of the lens and accordingly acquiring a well-defined and sharp projected image.

Given that the relationship between the projection distance and the motor position is not perfectly linear, ideally, the more samples of the motor positions corresponding to the predetermined projection distances, the closer to the theoretical design value of the relationship curve between the projection distances and the motor positions, and the better the auto-focus effect. However, the impracticality of establishing an extensive number of samples due to production constraints of labor hours necessitates the use of interpolation to calculate the corresponding motor position to perform a focus operation, which potentially compromises the clarity of the auto-focus image. Consequently, users often find it necessary to manually focus, introducing inconvenience.

Besides, default settings of the projection distance and the motor position may fail to deliver the best focusing effect over time due to the wear of motor parts or a decline in the performance of the distance sensor after a prolonged use.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

One or more embodiments of the invention provide a projection device and an auto-focus method thereof to effectively improve auto-focus effects of the projection device and better facilitate the use of the projection device.

Other objectives and advantages of the invention may be further understood from the technical features disclosed in the invention.

In order to achieve one, some, or all of the aforementioned objectives or other objectives, an embodiment of the invention provides a projection device that includes a projection lens, a distance detector, a motor, a driving circuit, and a control unit. The projection device is adapted to project an image beam to a projection surface. The projection lens is configured to project the image beam. The distance detector detects a projection distance between the projection lens and the projection surface to generate a distance detection signal. The motor is coupled to the projection lens and configured to control a movement of the projection lens. The driving circuit is coupled to the motor and driving the motor to move the projection lens to perform an auto-focus operation. The control unit is coupled to the distance detector and the driving circuit and stores an original look-up table and an expanded look-up table, where the original look-up table records a plurality of predetermined projection distances and a plurality of predetermined motor steps respectively corresponding to the predetermined projection distances, and the control unit is configured to: receive the distance detection signal from the distance detector, update the expanded look-up table according to the original look-up table, the distance detection signal, an optimal motor step, and an adjustment completion time, where the optimal motor step and the adjustment completion time are obtained through performing a manual-focus operation, and control the driving circuit to perform the auto-focus operation according to the distance detection signal and the updated expanded look-up table.

Another embodiment of the invention provides an auto-focus method of a projection device, and the auto-focus method includes following steps. A projection distance between a projection lens of the projection device and a projection surface is detected to generate a distance detection signal. A control unit is provided to receive the distance detection signal, where the control unit stores an original look-up table and an expanded look-up table, the original look-up table records a plurality of predetermined projection distances and a plurality of predetermined motor steps corresponding to the predetermined projection distances, and the control unit updates the expanded look-up table according to the original look-up table, the distance detection signal, an optimal motor step, and an adjustment completion time. Here, the optimal motor step and the adjustment completion time are obtained through performing a manual-focus operation. An auto-focus operation is performed according to the distance detection signal and the updated expanded look-up table.

In light of the foregoing, according to one or more of the embodiments of the invention, the expanded look-up table may be updated according to the original look-up table, the distance detection signal, the optimal motor step, and the adjustment completion time, and the driving circuit is controlled to perform the auto-focus operation according to the distance detection signal and the updated expanded look-up table, where the optimal motor step and the adjustment completion time are obtained through performing the manual-focus operation. As such, by continuously updating the expanded look-up table through performing the manual-focus operation and controlling the driving circuit to perform the auto-focus operation based on the updated expanded look-up table, the auto-focus effect of the projection device may be enhanced, and convenience of using the projection device may also be improved without requiring additional focus calibration operations by the user, and the auto-focus performance remains unaffected even in case of motor parts wear or a decline in the performance of the distance sensor.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a schematic diagram of a projection device according to another embodiment of the invention.

FIG. 3 is a schematic diagram of an auto-focus function menu according to an embodiment of the invention.

FIG. 4 is a schematic diagram of a relationship between a projection distance and a motor position according to an embodiment of the invention.

FIG. 5 is a schematic diagram of a restoration auto-focus function menu according to an embodiment of the invention.

FIG. 6 is a flowchart of an auto-focus method of a projection device according to an embodiment of the invention.

FIG. 7 is a flowchart of a method of updating an expanded look-up table according to an embodiment of the invention.

FIG. 8 is a flowchart of a method of restoring an expanded look-up table according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

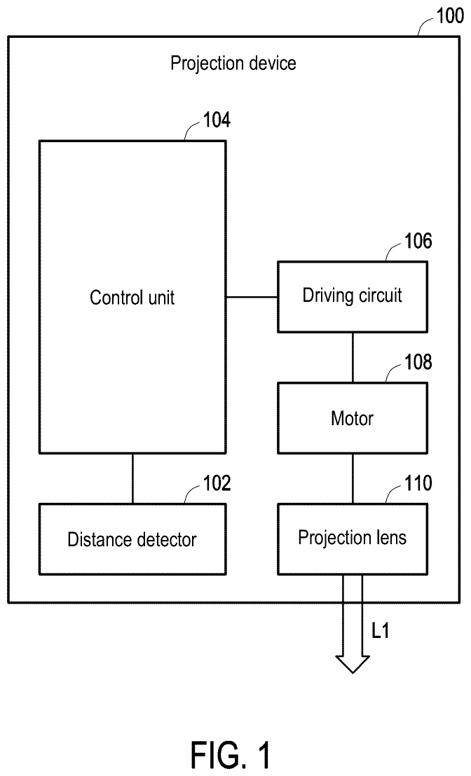

FIG. 1 is a schematic diagram of a projection device according to an embodiment of the invention. With reference to FIG. 1, a projection device 100 includes a distance detector 102, a control unit 104, a driving circuit 106, a motor 108, and a projection lens 110. The control unit 104 is coupled to the distance detector 102 and the driving circuit 106, and the motor 108 is coupled to the driving circuit 106 and the projection lens 110. An image beam L1 generated by the projection device 100 may be projected onto a projection surface (e.g., a projection screen, which should however not be construed as a limitation to the invention) through the projection lens 110. The distance detector 102 may detect a projection distance between the projection lens 110 and the projection surface to generate a distance detection signal, and the distance detector 102 may be implemented, for instance, in form of a laser distance sensor (e.g., a ToF sensor), an IR distance sensor, or an ultrasonic distance sensor, which should however not be construed as a limitation to the invention. The control unit 104 stores an original look-up table and an expanded look-up table, where the original look-up table records a plurality of predetermined projection distances and a plurality of predetermined motor steps corresponding to the predetermined projection distances. The control unit 104 may receive the distance detection signal generated by the distance detector 102 and update the expanded look-up table based on the original look-up table, the distance detection signal, an optimal motor step, and an adjustment completion time, where the optimal motor step and the adjustment completion time are obtained through performing a manual-focus operation. The recorded content of the updated expanded look-up table may include the predetermined projection distances and the predetermined motor steps in the original look-up table, the projection distance corresponding to the distance detection signal, a time when the manual-focus operation is completed, and a motor step (i.e., the adjustment completion time and the optimal motor step). The control unit 104 may control the driving circuit 106 to perform an auto-focus operation based on the distance detection signal and the updated expanded look-up table; namely, the control unit 104 controls the driving circuit 106 to drive the motor 108 to move the projection lens 110 to perform the auto-focus operation.

By continuously updating the expanded look-up table through performing the manual-focus operation, a relationship between the projection distance and the motor step in the expanded look-up table may be perfected and optimized without requiring additional focus calibration operations performed by a user. When the driving circuit is controlled to perform the auto-focus operation based on the updated expanded look-up table, the projection device may achieve the optimal auto-focus effect and accordingly improve the convenience of using the projection device. Even in case of motor parts wear or a decline in the performance of the distance sensor, the auto-focus performance remains unaffected.

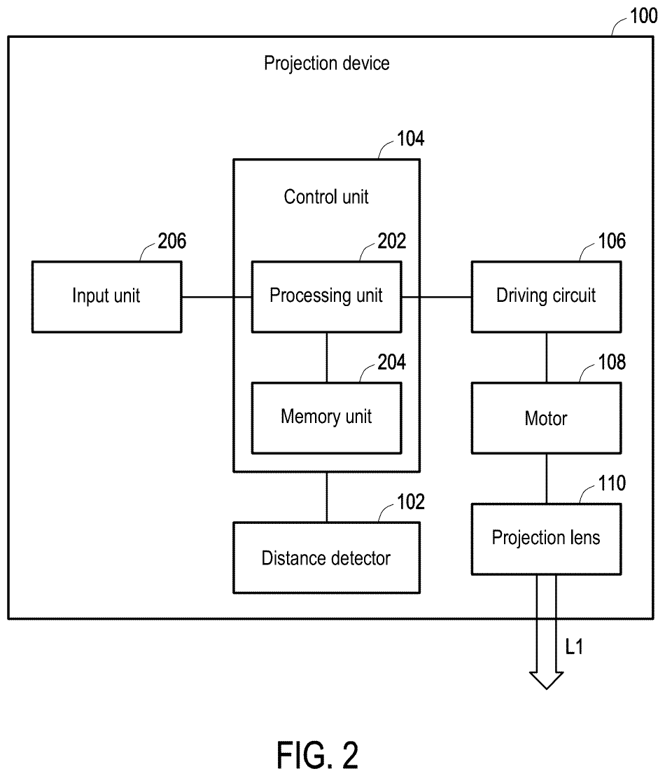

To be specific, the projection device 100 further includes an input unit 206. The control unit 104 of the projection device 100, as shown in FIG. 2, includes a processing unit 202 and a memory unit 204, where the processing unit 202 is coupled to the distance detector 102, the driving circuit 106, the memory unit 204, and the input unit 206. The processing unit 202 may be implemented in form of a processor, including but not limited to a central processing unit (CPU) or any other programmable general-purpose or special-purpose micro control unit (MCU) or microprocessor. The memory unit 204 may include a non-volatile storage device (such as a ROM or a flash memory) and a volatile storage device (such as a RAM), for instance. The input unit 206 may include a touch display panel or physical buttons, for instance, which should however not be construed as a limitation to the invention. The original look-up table and the expanded look-up table may be stored in the non-volatile storage device of the memory unit 204. When the processing unit 202 performs the auto-focus operation, the expanded look-up table may be stored in the volatile storage device for use, and after the expanded look-up table is updated, the updated expanded look-up table is stored back into the non-volatile storage device to synchronize the updated expanded look-up table stored in the non-volatile storage device.

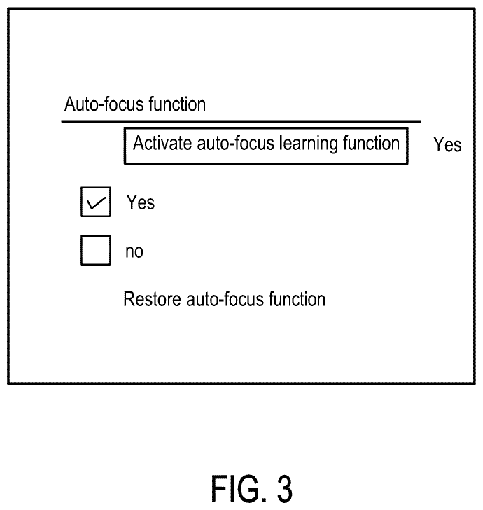

In addition, the input unit 206 is configured to accept user operations to set various functions of the projection device 100. For instance, the projection device 100 projects an on-screen display (OSD) to display an auto-focus function menu shown in FIG. 3. The projection device 100 may display the auto-focus function menu as shown in FIG. 3 in response to the user operations and present an option “activate auto-focus learning function” within the menu, and the user may select to activate or deactivate the auto-focus learning function. When the auto-focus learning function is activated, the processing unit 202 may carry out an operation of updating the expanded look-up table as described above, and when the auto-focus learning function is deactivated, the processing unit 202 exclusively performs the auto-focus operation based on the original look-up table.

Specifically, when the expanded look-up table is updated, the processing unit 202 may determine whether the projection distance corresponding to the distance detection signal coming from the distance detector 102 is equal to one of the predetermined projection distances. If the projection distance is equal to one of the predetermined projection distances, the projection distance, the optimal motor step, and the adjustment completion time are updated to the expanded look-up table to replace the corresponding original predetermined projection distance and predetermined motor step. However, if the projection distance is different from any of the predetermined projection distances, the projection distance corresponding to the distance detection signal, the corresponding optimal motor step, and the adjustment completion time are added to the expanded look-up table.

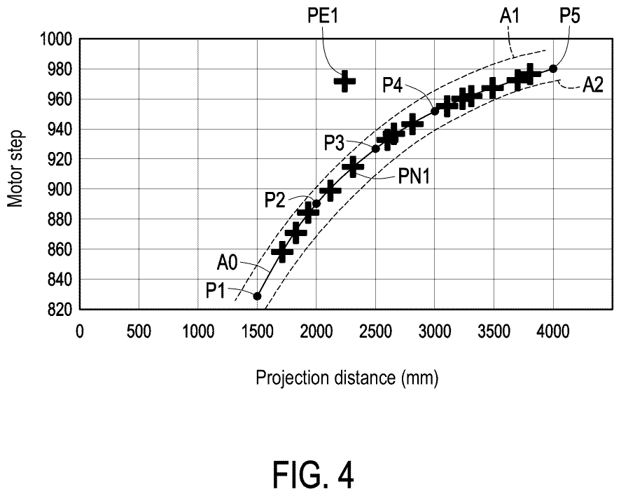

In some embodiments, the processing unit 202 may further determine whether the optimal motor step is within a reasonable range when the manual-focus operation is completed. If the optimal motor step is within a reasonable range, the projection distance corresponding to the distance detection signal, the optimal motor step, and the adjustment completion time may be directly updated to the expanded look-up table. The reasonable range of the optimal motor step may be as shown in FIG. 4 and defined by curves A1 and A2. A curve A0 generated by the predetermined projection distances and the predetermined motor steps recorded in the original look-up table falls between the curves A1 and A2. In the embodiment, the curve A0 is defined by predetermined sampling points P1-P5 stored in the original look-up table, and the curves A1 and A2 may be defined according to an error tolerance range (e.g., an upper limit value and a lower limit value of an error tolerance of the motor step) corresponding to the motor step of each predetermined sampling point P1-P5 on the curve A0.

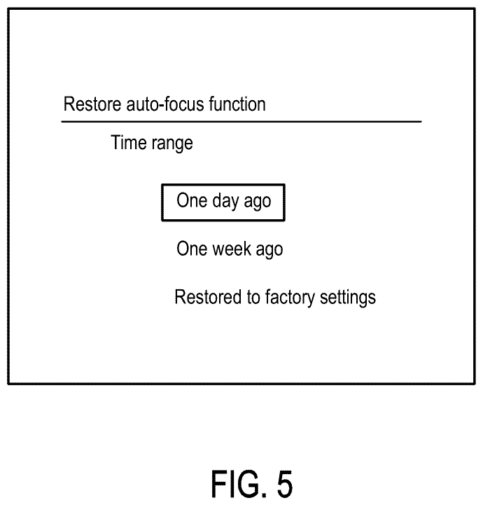

Upon completion of the manual-focus operation, if the processing unit 202 determines that the optimal motor step is not within a reasonable range, the processing unit 202 may control the projection device 100 to project a confirmation menu, and according to confirmation information generated according to operations performed on the input unit 206 by the user, decide whether to update the projection distance, the optimal motor step, and the adjustment completion time to the expanded look-up table. For instance, in the embodiment shown in FIG. 4, upon completion of the manual-focus operation, the distance detector 102 measures and obtains the projection distance as, for instance, 2200 mm, and the motor step obtained after the manual adjustment is, for instance, 970, then the processing unit 202 determines that a point PE1 corresponding to the projection distance and the motor step falls outside the range defined by the curves A1 and A2, and if the confirmation information of the user indicates not to update the projection distance, the optimal motor step, and the adjustment completion time to the expanded look-up table, the processing unit 202 does not update the expanded look-up table, so as to exclude inappropriate sampling points. By continuously updating the expanded look-up table in this manner, the curve A0 progressively approximates an ideal curve. During the auto-focus operation performed by the processing unit 202, if the projection distance corresponding to the distance detection signal is not recorded in the expanded look-up table, the processing unit 202 may employ interpolation to calculate the precise motor step based on the sampling points recorded in the expanded look-up table. In some embodiments, if the confirmation information of the user is not received, for instance, in case that the user does not operate the input unit 206, the processing unit 202 may cancel the confirmation menu after the confirmation menu is being projected for a predetermined period and does not update the expanded look-up table. In other embodiments, if the point PE1 falls outside the range defined by the curves A1 and A2, while the user directs an update to the projection distance, the optimal motor step, and the adjustment completion time to the expanded look-up table (i.e., the user indicates clarity while, in reality, the image is unclear), the user may also restore the settings of the projection device 100 (elaborated with reference to FIG. 5) if future use reveals image dissatisfaction.

By contrast, upon completion of the manual-focus operation, if the processing unit 202 determines that the point corresponding to the projection distance and the motor step (such as a point PN1 shown in FIG. 4) falls within the range defined by the curves A1 and A2, the processing unit 202 may record the projection distance, the final motor step, and the adjustment completion time as a sampling point and update it to the expanded look-up table in the volatile storage device and the non-volatile storage device of the memory unit 204 through replacement or addition. After updating the expanded look-up table in the memory unit 204 (the volatile storage device), the processing unit 202 may rearrange the order of the sampling points in the expanded look-up table, e.g., rearranging the order of the sampling points based on the projection distance. Such rearrangement may expedite the calculation of the motor step through interpolation.

Besides, the adjustment completion time recorded in the expanded look-up table may serve to restore the settings of the projection device 100, e.g., restoring the expanded look-up table to a state corresponding to the adjustment completion time. For instance, when the user performs a restoration operation through the input unit 206, the processing unit 202 may control the projection device 100 to project the OSD to display a restoration auto-focus function menu as shown in FIG. 5. The restoration auto-focus function menu enables the selection of a desired restoration time point; for instance, in the embodiment shown in FIG. 5, the expanded look-up table may be optionally restored to the state from one day ago, one week ago, or to the factory settings, which should however not be construed as a limitation to the invention. The range of the selectable restoration time points is linked to the adjustment completion time points stored in the expanded look-up table. The processing unit 202 may generate a command of restoring to a specific time point or a command of restoring to default settings based on the selection of the desired restoration time point by the user and restore the expanded look-up table to the corresponding time point. Specifically, the sampling points of the adjustment completion time points later than the specific time point in the expanded look-up table of the non-volatile memory device may be removed, and after the removal operation, the expanded look-up table in the non-volatile memory device may be loaded into the volatile memory device to rearrange the order of the sampling points in the expanded look-up table according to the projection distance. Similarly, if the user selects to restore the expanded look-up table to the factory settings, the processing unit 202 may restore the expanded look-up table to a state where the predetermined projection distances and the predetermined motor steps corresponding to the predetermined projection distances are exclusively included in the original look-up table according to the command of restoring to the default settings. In particular, according to the command of restoring to the default settings, the expanded look-up table in the non-volatile memory device may be replaced with the recorded content of the original look-up table, so that the expanded look-up table in the non-volatile memory device is restored to exclusively include the predetermined projection distances and the corresponding predetermined motor steps in the original look-up table, and then the order of the sampling points in the expanded look-up table is rearranged.

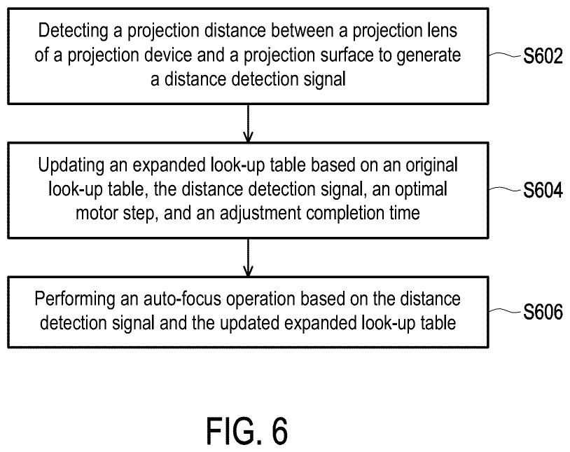

FIG. 6 is a flowchart of an auto-focus method of a projection device according to an embodiment of the invention. It can be learned from the above embodiments that the auto-focus method of the projection device may include at least following steps. First, the projection distance between the projection lens of the projection device and the projection surface is detected to generate the distance detection signal (step S602). The control unit is provided to receive the distance detection signal, where the control unit stores the original look-up table and the expanded look-up table, the original look-up table and the expanded look-up table record the predetermined projection distances and the corresponding predetermined motor steps, and the control unit updates the expanded look-up table based on the original look-up table, the distance detection signal, the optimal motor step, and the adjustment completion time (step S604). Here, the optimal motor step and the adjustment completion time are obtained through performing the manual-focus operation. The auto-focus operation is then performed based on the distance detection signal and the updated expanded look-up table (step S606).

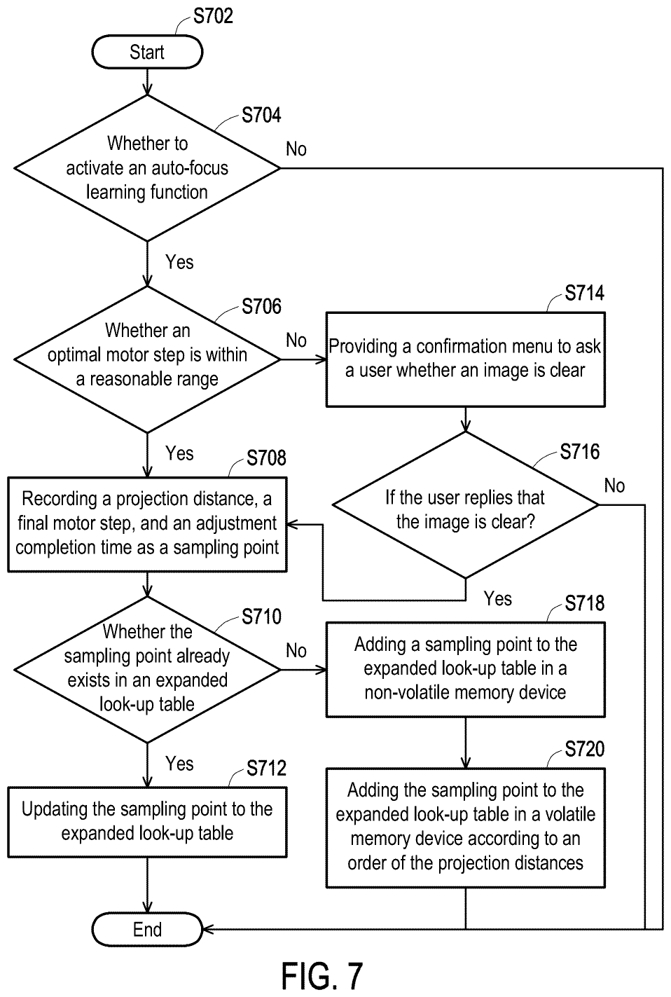

To be specific, a method of updating the expanded look-up table may be as shown in FIG. 7. In the beginning (step S702), i.e., when the user starts to operate the projection device 100, e.g., performing a manual-focus operation, a mode (e.g., a mode 1) linked to the auto-focus function is already preset in the projection device 100 when it leaves the factory. After the user completes the manual-focus operation for the first time, the projection device 100 automatically projects the OSD to display a menu for determining whether to activate the auto-focus learning function (as shown in FIG. 3). Alternatively, the mode may be a mode 2 which allows the user to actively operate the input unit 206 to display the auto-focus function menu shown in FIG. 3 through the OSD, which should however not be construed as a limitation to the invention. The mode 1 is taken as an example, and when the user starts to operate the projection device 100 and completes the manual-focus operation, the projection device 100 automatically projects the menu for determining whether to activate the auto-focus function menu and asks the user if the auto-focus learning function should be activated (step S704). If the auto-focus learning function is activated, whether the optimal motor step is within a reasonable range is determined (step S706). If the optimal motor step is within a reasonable range, the projection distance, the final motor step, and the adjustment completion time are recorded as a sampling point (step S708), and then whether the sampling point already exists in the expanded look-up table in the volatile storage device is determined (step S710), e.g., whether the projection distance corresponding to the distance detection signal is equal to one of the predetermined projection distances is determined. If the sampling point already exists in the expanded look-up table in the volatile memory device, the sampling point is updated to the expanded look-up table in the volatile memory device and the non-volatile memory device (step S712). For instance, when the projection distance is equal to one of the predetermined projection distances, the projection distance, the optimal motor step, and the adjustment completion time are updated to the expanded look-up table in the volatile memory device and the non-volatile memory device. By contrast, if the sampling point does not exist in the expanded look-up table, i.e., if the projection distance is different from any of the predetermined projection distances, a new sampling point is added to the expanded look-up table in the non-volatile memory device (step S718), i.e., adding the projection distance, the optimal motor step, and the adjustment completion time, and the sampling point is added to the expanded look-up table in the volatile memory device according to the order of the projection distances (step S720). As such, when the motor step is calculated through interpolation, the calculation of the motor step may be accelerated.

Additionally, in step S706, if it is determined that the optimal motor step is not within a reasonable range, a confirmation menu may be provided to ask the user whether an image projected by the projection device is clear (step S714), so as to learn whether the optimal motor step should be updated to the expanded look-up table. If the user replies in the confirmation menu in step S716 that the image is clear, step S708 is further performed to execute a series of subsequent actions to update the expanded look-up table. However, if the user replies in the confirmation menu in step S716 that the image is unclear, the step of updating the expanded look-up table is terminated, and the expanded look-up table is not updated.

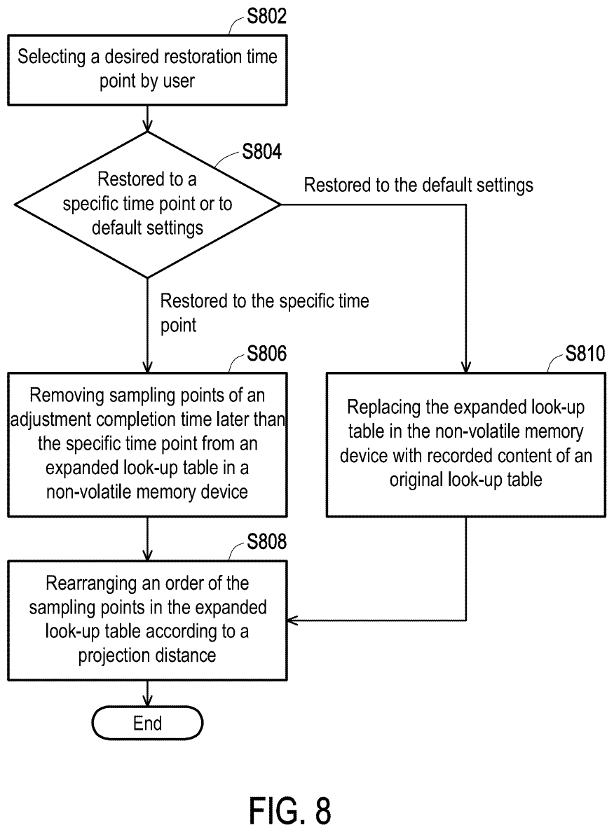

In addition, the method of restoring the expanded look-up table may be as shown in FIG. 8. The projection device is controlled to project the OSD to display the restoration auto-focus function menu, so that the user is allowed to select the desired restoration time point (step S802), where the adjustment completion time is linked to the desired restoration time point. Based on the selection of the desired restoration time point by the user, the command of restoring to the specific time point or the command of restoring to the default settings is generated (step S804). In the case of generating the command of restoring to the specific time point, the expanded look-up table is restored according to the command of restoring to the specific time point. Specifically, the sampling points of the adjustment completion time later than the specific time point (e.g., one day or one week before what is shown in FIG. 5) in the expanded look-up table in the non-volatile memory device may be removed (step S806). That is, the adjustment completion time later than the specific time point, the projection distance, and the optimal motor step are removed, after the removal operation the expanded look-up table in the non-volatile memory device is loaded into the volatile memory device, and the order of the sampling points in the expanded look-up table are rearranged according to the projection distance (step S808), so as to accelerate the calculation and acquisition of the motor step through interpolation. Besides, if restoring to the default settings is selected in step S804, according to the command of restoring to the default settings, the expanded look-up table in the non-volatile memory device is replaced with the recorded content of the original look-up table (step S810), thus enabling the expanded look-up table in the non-volatile memory device to restore to exclusively include the predetermined projection distances and the corresponding predetermined motor steps in the original look-up table. After that, in step S808, the order the sampling points in the expanded look-up table is rearranged.

To sum up, according to one or more of the embodiments of the invention, the expanded look-up table may be updated according to the original look-up table, the distance detection signal, the optimal motor step, and the adjustment completion time, and the driving circuit is controlled to perform the auto-focus operation according to the distance detection signal and the updated expanded look-up table, where the optimal motor step and the adjustment completion time are obtained through performing the manual-focus operation. As such, by continuously updating the expanded look-up table through performing the manual-focus operation and controlling the driving circuit to perform the auto-focus operation based on the updated expanded look-up table, the auto-focus effect of the projection device may be enhanced, and convenience of using the projection device may also be improved without requiring additional focus calibration operations by the user, and the auto-focus performance remains unaffected even in case of motor parts wear or a decline in the performance of the distance sensor. In some embodiments, the expanded look-up table may be further restored according to the adjustment completion time, whereby the convenience of using the projection device is enhanced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, adapted to project an image beam onto a projection surface and comprising:
a projection lens, configured to project the image beam;
a distance detector, detecting a projection distance between the projection lens and the projection surface to generate a distance detection signal;
a motor, coupled to the projection lens and configured to control a movement of the projection lens;
a driving circuit, coupled to the motor and driving the motor to move the projection lens to perform an auto-focus operation; and
a control unit, coupled to the distance detector and the driving circuit and storing an original look-up table and an expanded look-up table, wherein the original look-up table records a plurality of predetermined projection distances and a plurality of predetermined motor steps respectively corresponding to the predetermined projection distances, and the control unit is configured to:
receive the distance detection signal from the distance detector;
update the expanded look-up table according to the original look-up table, the distance detection signal, an optimal motor step, and an adjustment completion time, wherein the optimal motor step and the adjustment completion time are obtained through performing a manual-focus operation; and
control the driving circuit to perform the auto-focus operation according to the distance detection signal and the updated expanded look-up table.

2. The projection device as claimed in claim 1, wherein the expanded look-up table comprises the predetermined projection distances and the predetermined motor steps, the control unit is configured to:
determine whether the projection distance corresponding to the distance detection signal is equal to one of the predetermined projection distances,
if the projection distance is equal to one of the predetermined projection distances, update the projection distance, the optimal motor step, and the adjustment completion time to the expanded look-up table; and
if the projection distance is different from any of the predetermined projection distances, add the projection distance, the optimal motor step, and the adjustment completion time to the expanded look-up table.

3. The projection device as claimed in claim 1, wherein the control unit is configured to:
control the projection device to project a restoration auto-focus function menu, wherein the restoration auto-focus function menu is configured to select a desired restoration time point, wherein the adjustment completion time is linked to the desired restoration time point, and according to the selection of the desired restoration time point by a user, a command of restoring to a specific time point or a command of restoring to default settings is generated.

4. The projection device as claimed in claim 3, wherein the control unit is configured to:
restore the expanded look-up table according to the command of restoring to the specific time point.

5. The projection device as claimed in claim 3, wherein the control unit is configured to:
according to the command of restoring to the default settings, restore the expanded look-up table to exclusively have the predetermined projection distances and the corresponding predetermined motor steps.

6. The projection device as claimed in claim 1, wherein the control unit is configured to:
upon completion of the manual-focus operation, determine that the optimal motor step is within a reasonable range, so as to update the projection distance, the optimal motor step, and the adjustment completion time to the expanded look-up table.

7. The projection device as claimed in claim 1, wherein the control unit is configured to:
upon completion of the manual-focus operation, determine that the optimal motor step is not within a reasonable range;
receive confirmation information from a user to decide whether to update the projection distance, the optimal motor step, and the adjustment completion time to the expanded look-up table.

8. The projection device as claimed in claim 1, wherein the control unit is configured to:
control the projection device to project auto-focus function menu, wherein the auto-focus function menu is configured to set whether to enable an auto-focus learning function.

9. An auto-focus method of a projection device, comprising:
detecting a projection distance between a projection lens of the projection device and a projection surface to generate a distance detection signal;
providing a control unit to receive the distance detection signal, wherein the control unit stores an original look-up table and an expanded look-up table, the original look-up table records a plurality of predetermined projection distances and a plurality of predetermined motor steps corresponding to the predetermined projection distances, and the control unit updates the expanded look-up table according to the original look-up table, the distance detection signal, an optimal motor step, and an adjustment completion time, wherein the optimal motor step and the adjustment completion time are obtained through performing a manual-focus operation; and
performing an auto-focus operation according to the distance detection signal and the updated expanded look-up table.

10. The auto-focus method as claimed in claim 9, wherein the expanded look-up table comprises the predetermined projection distances and the predetermined motor steps, and the auto-focus method comprises:
determining whether the projection distance corresponding to the distance detection signal is equal to one of the predetermined projection distances,
if the projection distance is equal to one of the predetermined projection distances, updating the projection distance, the optimal motor step, and the adjustment completion time to the expanded look-up table; and
if the projection distance is different from any of the predetermined projection distances, adding the projection distance, the optimal motor step, and the adjustment completion time to the expanded look-up table.

11. The auto-focus method as claimed in claim 9, comprising:
controlling the projection device to project a restoration auto-focus function menu, wherein the restoration auto-focus function menu is configured to select a desired restoration time point, wherein the adjustment completion time is linked to the desired restoration time point, and according to the selection of the desired restoration time point by a user, generating a command of restoring to a specific time point or a command of restoring to default settings.

12. The auto-focus method as claimed in claim 11, comprising:
restoring the expanded look-up table according to the command of restoring to the specific time point.

13. The auto-focus method as claimed in claim 11, comprising:
according to the command of restoring to the default settings, restoring the expanded look-up table to exclusively have the predetermined projection distances and the corresponding predetermined motor steps.

14. The auto-focus method as claimed in claim 9, comprising:
upon completion of the manual-focus operation, determining that the optimal motor step is within a reasonable range and updating the projection distance, the optimal motor step, and the adjustment completion time to the expanded look-up table.

15. The auto-focus method as claimed in claim 9, comprising:
upon completion of the manual-focus operation, determining that the optimal motor step is not within a reasonable range and deciding whether to update the projection distance, the optimal motor step, and the adjustment completion time to the expanded look-up table according to confirmation information from a user.

16. The auto-focus method as claimed in claim 9, comprising:
controlling the projection device to project auto-focus function menu, wherein the auto-focus function menu is configured to set whether to enable an auto-focus learning function.
